(19) United States
(12) Patent Application Publication
(10) Pub. No.: US 2012/0308713 A1
(43) Pub. Date: Dec. 6, 2012

(54) NOPAL KIMCHI

(76) Inventor: Jin-Soo Lee, Siheung-si (KR)

(21) Appl. No.: 13/578,370

(22) PCT Filed: Dec. 28, 2010
(86) PCT No.: PCT/KR10/09379

§ 371 Date: Aug. 10, 2012

(30) Foreign Application Priority Data
Oct. 29, 2010 (KR) 10-2010-0106670

(51) Int. Cl. A23L 1/218; A23L 1/221

(52) U.S. Cl. 426/615

(57) ABSTRACT

The present invention relates to nopal kimchi which is prepared with the addition of nopal and tuna juice which are familiar to Americans or Central and South Americans, thereby facilitating consumption by foreigners due to the alleviation of the spicy taste and smell unique to kimchi and enhancing the health of a person eating the same due to the nutrients contained in nopal and tuna. According to the present invention, the nopal kimchi comprises salted Chinese cabbage, salted nopal, and a kimchi seasoning containing tuna juice. The salted Chinese cabbage is prepared by adding 90-120 parts by weight of sea salt to 600-800 parts by weight of Chinese cabbage and salting the same for 5-7 hours. The salted nopal is prepared by adding 12-18 parts by weight of sea salt to 120-160 parts by weight of nopal, and salting the same for 0.5-1.5 hours. The kimchi seasoning containing tuna juice comprises 120-160 parts by weight of chopped radish, 40-50 parts by weight of Welsh onion, 20-25 parts by weight of chopped garlic, 10-13 parts by weight of chopped ginger, 24-30 parts by weight of chopped undried red pepper, 35-30 parts by weight of cooked rice, 22-25 parts by weight of myeolchi aekjeot (anchovy-based fish sauce), 6-9 parts by weight of saeujeot (salted fermented shrimp), 25-30 parts by weight of powdered hot pepper, 60-70 parts by weight of tuna juice, and 2-5 parts by weight of dried sesame seeds mixed with salt.

### TECHNICAL FIELD

The present invention relates to nopal Kimchi, and more particularly, to nopal Kimchi that contains nopal (Opuntia Ficus-Indica), which is the stem (leaf) of nopal (Opuntia Ficus-Indica) cactus, and a tuna (prickly pear) extract, which is a nopal (Opuntia Ficus-Indica) fruit extract.

### BACKGROUND ART

In general, Kimchi is a traditional Korean dish that is fermented at a low temperature by production of lactic acid after various vegetables such as Chinese cabbage and radish are pickled in salt and mixed with all sorts of spices, such as chopped red pepper, chopped garlic, greet onion, chopped ginger, salted fish, and others, and is an indispensable side dish that accompanies a traditional Korean meal.

However, there is a limit to globalize Kimchi because it may be disstressing for foreigners, who are unfamiliar to the spicy taste and smell unique to Kimchi, to eat Kimchi.

### DISCLOSURE

### Technical Problem

Accordingly, the present invention has been made in an effort to solve the above-mentioned problems occurring in the prior arts, and it is an object of the present invention to provide nopal Kimchi that is prepared with the addition of nopal (Opuntia Ficus-Indica) and tuna (prickly pear) juice, which are familiar to Americans or Central and South Americans, thereby facilitating consumption by foreigners due to the alleviation of the spicy taste and smell unique to kimchi.

It is another object of the present invention to provide nopal Kimchi that can enhance the health of a person eating the same due to the nutrients contained in nopal (Opuntia Ficus-Indica) and tuna (prickly pear).

### Technical Solution

To achieve the above objects, the present invention provides nopal Kimchi including salted Chinese cabbage, salted nopal (Opuntia Ficus-Indica), and Kimchi seasoning containing tuna (prickly pear) juice.

According to desirable characteristics of the present invention, the salted Chinese cabbage is prepared by adding 90-120 parts by weight of sea salt to 600--800 parts by weight or Chinese cabbage and salting the same for 5-7 hours, the salted nopal (Opuntia Ficus-Indica) is prepared by adding 12-18 parts by weight of sea salt to 120-160 parts by weight of nopal (Opuntia Ficus-Indica) and salting the same for 0.5-1.5 hours, and the kimchi seasoning containing tuna (prickly pear) juice includes 120-160 parts by weight of shredded radish, 40-50 parts by weight of green onion, 20-25 parts by weight of chopped garlic, 10-13 parts by weight of chopped ginger, 24-30 parts by weight of chopped undried red pepper, 25-30 parts by weight of cooked rice, 22-25 parts by weight of myeolchi aekjeot (anchovy-based fish sauce), 6-9 parts by weight of saeujeot (salted fermented shrimp), 25-30 parts by weight of powdered hot pepper, 60-70 parts by weight of tuna (prickly pear) juice, and 2-5 parts by weight of dried sesame seeds mixed with salt.

According to more desirable characteristics of the present invention, the salted Chinese cabbage is prepared by adding 108.90 parts by weight of sea salt to 700 parts by weight of Chinese cabbage and salting the same for 6 hours, the salted nopal (Opuntia Ficus-Indica) is prepared by adding 15.56 parts by weight of sea salt to 140 parts by weight of nopal (Opuntia Ficus-Indica) and salting the same for one hour, and the kimchi seasoning containing tuna (prickly pear) juice comprises 140 parts by weight of shredded radish, 46.67 parts by weight of green onion, 23.34 parts by weight of chopped garlic, 11.67 parts by weight of chopped ginger, 28.78 parts by weight of chopped undried red pepper, 27.22 parts by weight of cooked rice, 23.34 parts by weight of myeolchi aekjeot (anchovy-based fish sauce), 7.78 parts by weight of saeujeot (salted fermented shrimp), 27.22 parts by weight of powdered hot pepper, 66.12 parts by weight of tuna (prickly pear) juice, and 3.89 parts by weight of dried sesame seeds mixed with salt.

The salted Chinese cabbage and the salted nopal (Opuntia Ficus-Indica) are mixed with the Kimchi seasoning containing tuna (prickly pear) juice, matured at room temperature for 6-10 hours, and then stored in a refrigerator at a temperature of 2° C. to 4° C. before eating.

### Advantageous Effects

According to the present invention, nopal Kimchi can facilitate consumption by foreigners and globalization of Kimchi due to the alleviation of the spicy taste and smell unique to Kimchi because nopal Kimchi is prepared with the addition of nopal (Opuntia Ficus-Indica) and tuna (prickly pear) juice, which are familiar to Americans or Central and South Americans, and with the addition of a great deal of chopped undried red pepper, which has a light spicy taste.

Moreover, nopal Kimchi can enhance the health of a person eating the same due to the nutrients contained in nopal (Opuntia Ficus-Indica) and tuna (prickly pear).

### DESCRIPTION OF DRAWINGS

FIG. 1 is a flow chart showing a nopal Kimchi making process according to the present invention.

### DETAILED DESCRIPTION OF THE PREFERRED EMBODIMENTS

The preferred embodiment of the present invention will be described in this specification in detail referring to the attached drawing, but its intent is to enable those skilled in the art to easily embody from the following detailed description. Accordingly, it should be understood that there is no intent to limit the technical idea and scope of the present invention to the particular embodiment disclosed.

Nopal Kimchi according to the present invention is prepared with the addition of nopal (Opuntia Ficus-Indica) and tuna (prickly pear) juice, and hence, can facilitate consumption by foreigners due to the alleviation of the spicy taste and smell unique to kimchi, and enhance the health of a person eating the same due to the nutrients contained in nopal (Opuntia Ficus-Indica) and tuna (prickly pear). The nopal Kimchi includes salted Chinese cabbage, salted nopal (Opuntia Ficus-Indica), and Kimchi seasoning containing tuna (prickly pear) juice.

Here, the salted Chinese cabbage is prepared by adding 90-120 parts by weight of sea salt to 600-800 parts by weight of Chinese cabbage, which is cleaned and washed, and salting the same for 5-7 hours. Particularly, it is preferable that the salted Chinese cabbage is prepared by adding 108.90 parts by weight of sea salt to 700 parts by weight of Chinese cabbage and salting the same for 6 hours.

The reason for salting the Chinese cabbage is to season the Chinese cabbage, which is the main ingredient of Kimchi, with salt and to remove excessive moisture contained in the Chinese cabbage through the osmotic action. The process of salting the Chinese cabbage is well-known, and hence, the detailed description of the process will be omitted for simplification of specification.

The salted nopal (Opuntia Ficus-Indica) is prepared by adding 12-18 parts by weight of sea salt to 120-160 parts by weight of nopal (Opuntia Ficus-Indica), which is washed after thorns are removed, and salting the same for 0.5 hours to 1.5 hours. Particularly, it is preferable that the salted nopal (Opuntia Ficus-Indica) is prepared by adding 15.56 parts by weight of sea salt to 140 parts by weight of nopal (Opuntia Ficus-Indica) and salting the same for one hour.

Nopal (Opuntia Ficus-Indica) is a stem (leaf) of nopal (Opuntia Ficus-Indica) cactus and contains 18 kinds of amino acids, such as methionine, leucin, arginine and others, 40 kinds of plant compounds, such as lysine, aspartic acid, phosphorus and others, and a great deal of celluloses so as to strengthen the functions of liver or pancreas, promote glycometabolism by activating insulin, increase the level of immunity, enhance functions of the heart, stomach and kidney and the sexual function, and shows an excellent effect in relieving constipation.

The reason for salting the nopal (Opuntia Ficus-Indica) is to season nopal (Opuntia Ficus-Indica) with salt and to remove excessive moisture contained in nopal (Opuntia Ficus-Indica) through the osmotic action. The process of salting the nopal (Opuntia Ficus-Indica) is similar to the Chinese cabbage salting process, and hence, the detailed description of the process will be omitted for simplification of specification.

Nopal Kimchi according to the present invention is based on the traditional Korean cabbage Kimchi, and the most preferable mixture ratio of the salted Chinese cabbage to the salted nopal (Opuntia Ficus-Indica) is a weight ratio of 5:1.

The salted Chinese cabbage and the salted nopal (Opuntia Ficus-Indica) are mixed with Kimchi seasoning containing tuna (prickly pear) juice. The Kimchi seasoning containing tuna (prickly pear) juice includes 120-160 parts by weight of shredded radish, 40-50 parts by weight of green onion, 20-25 parts by weight of chopped garlic, 10-13 parts by weight of chopped ginger, 24-30 parts by weight of chopped undried red pepper, 25-30 parts by weight of cooked rice, 22-25 parts by weight of myeolchi aekjeot (anchovy-based fish sauce), 6-9 parts by weight of saeujeot (salted fermented shrimp), 25-30 parts by weight of powdered hot pepper, 60-70 parts by weight of tuna (prickly pear) juice, and 2-5 parts by weight of dried sesame seeds mixed with salt. Particularly, it is preferable that the Kimchi seasoning containing tuna (prickly pear) juice includes 140 parts by weight of shredded radish, 46.67 parts by weight of green onion, 23.34 parts by weight of chopped garlic, 11.67 parts by weight of chopped ginger, 28.78 parts by weight of chopped undried red pepper, 27.22 parts by weight of cooked rice, 23.34 parts by weight of myeolchi aekjeot (anchovy-based fish sauce), 7.78 parts by weight of saeujeot (salted fermented shrimp), 27.22 parts by weight of powdered hot pepper, 66.12 parts by weight of tuna (prickly pear) juice, and 3.89 parts by weight of dried sesame seeds mixed with salt.

The Kimchi seasoning containing tuna (prickly pear) juice includes shredded radish, green onion, chopped garlic, chopped ginger, chopped un-dried red pepper, cooked rice (corresponding to rice gruel), myeolchi aekjeot (anchovy-based fish sauce), saeujeot (salted fermented shrimp), powdered hot pepper, and dried sesame seeds mixed with salt, which are used in conventional Kimchi seasoning. However, the Kimchi seasoning containing tuna (prickly pear) juice according to the present invention is differentiated from the conventional Kimchi seasoning in the sense that the chopped garlic content and the chopped ginger content and the powdered red pepper content are reduced dramatically and a great deal of the chopped undried red pepper are added in order to minimise the spicy taste and smell of Kimchi. Especially, the Kimchi seasoning containing tuna (prickly pear) juice according to the present invention is differentiated from the conventional Kimchi seasoning in the sense that a great deal of tuna (prickly pear), which is a fruit of nopal (Opuntia Ficus-Indica) cactus, in the form of juice is added in Kimchi seasoning.

Tuna (prickly pear) contains 18 kinds of amino acids, 14 kinds of vitamins, polyphenol and flavonoid providing antioxidative action, various kinds of vitamins dietary fiber, calcium, magnesium, and others so as to strengthen functions of kidney and stomach, promote hormone secretion, relieve chronic fatigue, and reduce obesity and the cholesterol level.

Furthermore, nopal (Opuntia Ficus-Indica) and tuna (prickly pear) are highly effective in removing smell unique to Kimchi and double the taste of Kimchi.

Additionally, it is preferable that undried pepper is prepared by mixing undried hot pepper and undried normal pepper at the ratio of 1.2, and it is also preferable that rice for cooking is rice of California growth rather than rice of Korea growth.

The salted Chinese cabbage and the salted nopal (Opuntia Ficus-Indica) are mixed with the Kimchi seasoning containing tuna (prickly pear) juice, matured at room temperature for 6-10 hours, and then, stored in a refrigerator at temperature of 2° C. to 4° C. before eating.

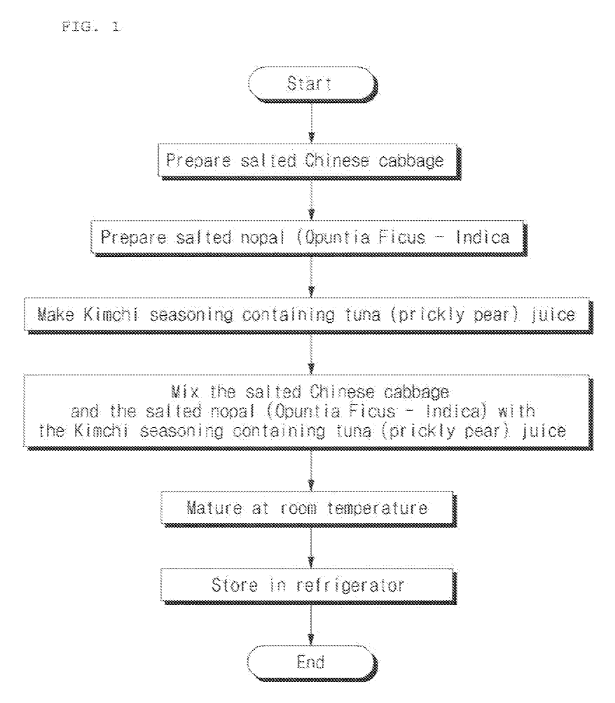

Hereinafter referring to FIG. 1, a method of making nopal Kimchi according to the present invention will be described in detail as follows.

First, salted Chinese cabbage is prepared by adding 108.90 g of sea salt to 700 g of Chinese cabbage, which is cleaned and washed, and salting the same for 6 hours. After that, salted nopal (Opuntia Ficus-Indica) is prepared by cutting 140 g of nopal (Opuntia Ficus-Indica), which is washed after thorns are removed, adding 15.56 g of sea salt to the cut nopal (Opuntia Ficus-Indica), and salting the same for one hour.

Next, Kimchi seasoning containing tuna (prickly pear) juice is prepared by mixing 140 g of shredded radish, 46.67 g of green onion, 23.34 g of chopped garlic, 11.67 g of chopped ginger, 28.78 g of chopped undried red pepper, 27.22 g of cooked rice, 23.34 g of myeolchi aekjeot (anchovy-based fish sauce), 7.78 g of saeujeot (salted fermented shrimp), 27.22 g of powdered hot pepper, 66.12 g of tuna (prickly pear) juice, and 3.89 g of dried sesame seeds mixed with salt.

Next, when the salted Chinese cabbage and the salted nopal (Opuntia Ficus-Indica) are mixed with the Kimchi seasoning containing tuna (prickly pear) juice, 1 kg of nopal Kimchi (370.49 g out of 1370.49 g is dehydrated while Chinese cabbage and nopal [Opuntia Ficus-Indica] are salted) according to the present invention is made. The nopal Kimchi is matured at room temperature for about 8 hours, and then stored in tire refrigerator at a temperature of 4° C. before eating.

As a result of giving 30 foreigners a taste of nopal Kimchi made according to the present invention, 25 foreigners said that nopal Kimchi was very tasty, but just one foreigner said that nopal Kimchi could not be eaten.

### INDUSTRIAL APPLICABILITY

Nopal Kimchi according to the present invention is revised from traditional Korean Kimchi in such a way as to be palatable to foreigner's so as to globalize Kimchi, so that the production and consumption of Kimchi can be expanded overseas.

1. Nopal Kimchi comprising:
salted Chinese cabbage;
sailed nopal Opuntia Ficus-Indica); and
Kimchi seasoning containing tuna (prickly pear) juice.

2 The Nopal Kimchi according to claim 1, wherein the salted Chinese cabbage is prepared by adding 90-120 parts by weight of sea salt to 600-800 parts by weight of Chinese cabbage and salting the same for 5-7 hours, the salted nopal (Opuntia Ficus-Indica) is prepared by adding 12-18 parts by weight of sea salt to 120-160 parts by weight of nopal (Opuntia Ficus-Indica) and salting the same for 0.5-1.5 hours, and the kimchi seasoning containing tuna (prickly pear) juice comprises 120-180parts by weight of shredded radish, 40-50 parts by weight of green onion, 20-25 parts by weight of chopped garlic, 10-13 parts by weight of chopped ginger, 24-30 parts by weight of chopped undried red pepper, 25-30 parts by weight of cooked rice, 22-25parts by weight of myeolchi aekjeot (anchovy-based fish sauce), 6-9 parts by weight of saeujeot (salted fermented shrimp), 25-30 parts by weight of powdered hot pepper, 60-70 parts by weight of tuna (prickly pear) juice, and 2-5 parts by weight of dried sesame seeds mixed with salt.

3. The Nopal Kimchi according to claim 1, wherein the salted Chinese cabbage is prepared by adding 108.90 parts by weight of sea salt to 700 parts by weight of Chinese cabbage and salting the same for 6 hours, the salted nopal (Opuntia Ficus-Indica) is prepared by adding 15.56 parts by weight of sea salt to 140 parts by weight of nopal (Opuntia Ficus-Indica) and salting the same for one hour, and the kimchi seasoning containing tuna (prickly pear) juice comprises 140 parts by weight of shredded radish, 46.67 parts by weight of green onion, 23.34 parts by weight of chopped garlic, 11.67 parts by weight of chopped ginger, 28.78 parts by weight of chopped undried red pepper, 27.22 parts by weight of cooked rice, 23.34 parts by weight of myeolchi aekjeot (anchovy-based fish sauce), 7.78 parts by weight of saeujeot (salted fermented shrimp), 27.22 parts by weight of powdered hot pepper, 66.12 parts by weight of tuna (prickly pear) juice, and 3.89 parts by weight of dried sesame seeds mixed with salt.

4. The Nopal Kimchi according to claim 1, wherein the salted Chinese cabbage and the salted nopal (Opuntia Ficus-Indica) are mixed with the Kimchi seasoning containing tuna (prickly pear) juice, matured at room temperature for 6-10 ours, and then, stored in a refrigerator at a temperature of 2° C. to 4° C. before eating.

5. The Nopal Kimchi according to claim 2, wherein the salted Chinese cabbage and the salted nopal (Opuntia Ficus-Indica) are mixed with the Kimchi seasoning containing tuna (prickly pear) juice, matured at room temperature for 6-10 ours, and then, stored in a refrigerator at a temperature of 2° C. to 4° C. before eating.

6. The Nopal Kimchi according to claim 3, wherein the salted Chinese cabbage and the salted nopal (Opuntia Ficus-Indica) are mixed with the Kimchi seasoning containing tuna (prickly pear) juice, matured at room temperature for 6-10ours, and then, stored in a refrigerator at a temperature of 2° C. to 4° C. before eating.
